(19) United States
(12) Patent Application Publication
(10) Pub. No.: US 2020/0300472 A1
(43) Pub. Date: Sep. 24, 2020

(54) FUEL INJECTOR FOR A TURBINE ENGINE

(71) Applicant: SAFRAN AIRCRAFT ENGINES, Paris (FR)

(72) Inventors: José Roland RODRIGUES, MOISSY-CRAMAYEL (FR); Hugo Charles DENEUVILLE, MOISSY-CRAMAYEL (FR)

(21) Appl. No.: 16/825,132

(22) Filed: Mar. 20, 2020

(30) Foreign Application Priority Data
Mar. 20, 2019 (FR) 1902846

(51) Int. Cl. F23R 3/34; F02C 7/232

(52) U.S. Cl. CPC F23R 3/346; F02C 9/263; F02C 7/232

(57) ABSTRACT

The invention relates to a fuel injector for a turbine engine, comprising a body having a fuel inlet opening into an upstream chamber and a fuel outlet connected to a downstream chamber, a metering valve being mounted between the upstream chamber and the downstream chamber, said valve being subjected to the action of an elastic return spring tending to return the valve to a closed position, the spring (11) and the valve being designed to allow the opening of the valve and to allow the passage of fuel from the upstream chamber to the downstream chamber, above a given fuel pressure in the upstream chamber, the return spring (11) extending along the axis (X) of movement of the valve, characterized in that the spring (11) has a first axial end and a second axial end, both annular, connected to one another by at least two helical parts (11c, 11d) elastically deformable in the axial direction (X).

### CROSS-REFERENCE TO RELATED APPLICATION

This application claims priority to French Patent Application No. 1902846, filed Mar. 20, 2019, which is incorporated herein by reference.

### TECHNICAL FIELD OF THE INVENTION

The present invention relates to a fuel injector for a turbine engine, particularly for an aircraft turbojet engine or a turboprop engine.

### PRIOR ART

A turbine engine conventionally comprises an annular combustion chamber with evenly distributed fuel injectors at its upstream end and means for supplying air around the injectors. There are mainly two types of injectors, namely the so-called aeromechanical injectors with two fuel circuits offering fuel flow rates adapted to different operating phases of the turbine engine, (the ignition phase, the low or full power operating phase), and the so-called aerodynamic injectors which have only one fuel circuit for all the operating phases of the turbine engine.

The patent application FR 2 832 492, in the name of the Applicant, describes an aeromechanical type injector, comprising a primary fuel circuit intended, for example, for an ignition and low-power phase, and a secondary circuit for subsequent medium- to high-power phases of operation, in addition to the primary circuit.

This type of injector comprises a body comprising pressurized fuel intake means, a shut-off valve mounted in the body downstream of the intake means and designed to open under a first determined fuel pressure and to remain open above this first pressure in order to supply a primary fuel circuit, and a metering valve mounted in the body downstream of the shut-off valve and designed to open beyond a second determined fuel pressure, higher than the first pressure, and to remain open beyond the second pressure in order to supply a secondary fuel circuit.

The fuel flow rate in the secondary circuit is controlled by means of metering slots provided in the metering valve, the flow cross-sections of which vary according to the position of the metering valve, i.e. according to the fuel supply pressure. The higher the fuel supply pressure, the larger the passage cross-sections of the slots.

The metering valve is subject to the action of an elastic return spring which tends to return the valve to a closed position. The spring is a helical spring of a conventional structure, i.e. formed by a single metal wire of a generally helical shape, the ends of which extend in a plane generally perpendicular to the spring axis.

Due to the buckling stress and friction generated by such a spring, the compression and expansion curves of the spring are significantly different from one another, creating a significant hysteresis phenomenon. The compression or expansion curve represents the variation of the return force exerted by the spring as a function of the length of the spring, during its compression or expansion. This leads to fuel flow rate or pressure characteristics which are different in the opening or closing phase of the metering valve, which generates heterogeneity between different injectors having the same structure within the same turbine engine, or wear by friction of the metering valve or of the elements surrounding said valve.

### DISCLOSURE OF THE INVENTION

The invention aims to remedy such drawback in a simple, reliable and inexpensive way. For this purpose, the invention relates to a fuel injector for a turbine engine, comprising a body having a fuel inlet opening into an upstream chamber, and a fuel outlet connected to a downstream chamber, a metering valve being mounted between the upstream chamber and the downstream chamber, said valve being subjected to the action of an elastic return spring tending to return the valve to a closed position, the spring and the valve being designed to allow the opening of the valve and to allow the passage of fuel from the upstream chamber to the downstream chamber, above a given fuel pressure in the upstream chamber, the return spring extending along the axis of movement of the valve, characterized in that the spring has a first axial end and a second axial end which are annular and which are connected to one another by at least two helical parts which are elastically deformable in the axial direction.

The terms “axial” and “radial” are defined relative to the axis of movement of the valve, which corresponds to the axis of movement of the spring.

Such a spring structure limits the buckling force and the radial deformation of the spring during operation, thus limiting friction and the resulting hysteresis. This ensures a better operation of the injectors.

The number of helical parts can be equal to or greater than two, for example equal to three or four.

The helical parts can be evenly distributed around the circumference.

The helical parts may have the same diameter, which helps to distribute the forces during operation, so as to avoid uneven deformation or buckling of the spring. Such a feature also reduces the radial dimensions of the spring. The number of turns may range from 2 to 6, preferably 2 to 3.

The number of turns may or may not be an integer. The number of turns ranges from 3 to 4.

The spring can be made in one piece from a metallic material, e.g. steel, titanium or a titanium alloy.

This angle is dependent, among other things, on the number of turns and the axial distance of the spring.

### BRIEF DESCRIPTION OF THE FIGURES

[FIG. 1] is a cross-sectional axial view of an injector according to one embodiment of the prior art,

[FIG. 2] is a front view of an injector according to one embodiment of the invention.

FIG. 1 shows an injector 1 according to the prior art. The latter comprises a body 2 comprising a main part 2a extending along an axis X and intended to be fixed by means of screws 3 to a stationary part 4 of the turbine engine, and an injection part 2b extending perpendicularly to the axis X, from a so-called lower end of the main part 2a. The terms high and low are defined in relation to FIG. 1 and are not necessarily related to the actual orientation of the injector 1 in the turbine engine.

The main part 2a of the body 2 comprises a recess delimiting an upstream chamber 5 into which a fuel inlet 6 opens, and a downstream chamber 7 connected to a fuel flow channel 8 opening at a fuel outlet 9.

The fuel flow channel 8 has an axial part 8a opening upwards into the downstream chamber 7 and a radial part 8b extending substantially perpendicularly to the axis X, opening outwards from the injector at the outlet 9 so as to form an injection nozzle.

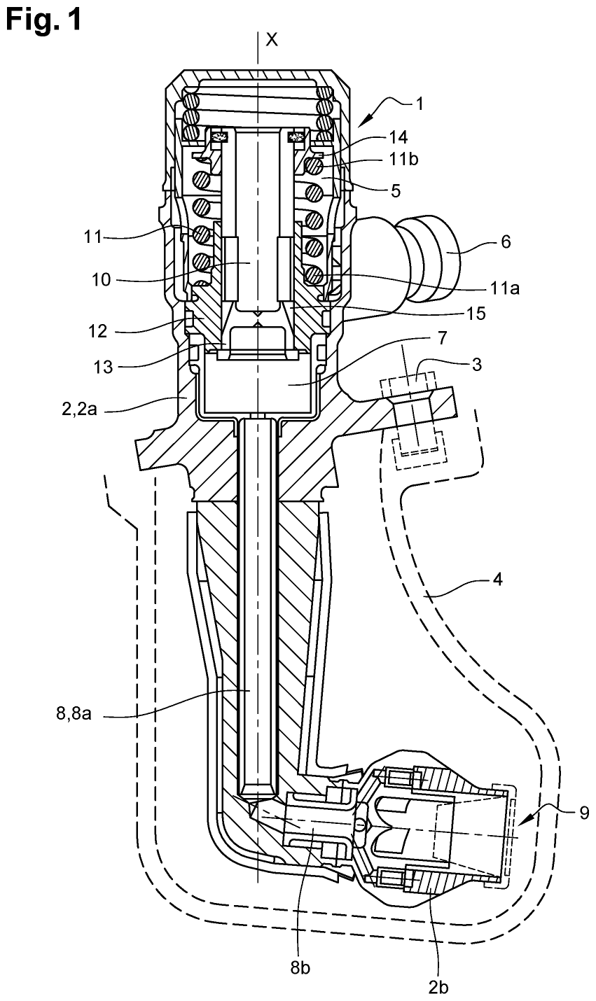

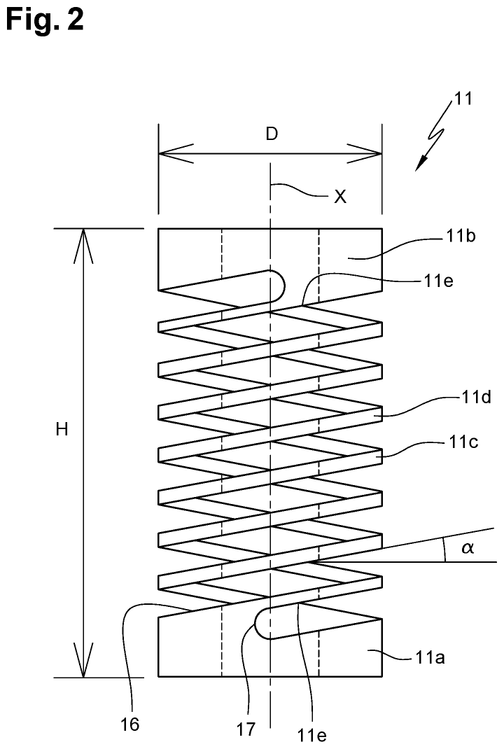

The upstream chamber 5 and the downstream chamber 7 are separated from one another by a metering valve 10 which is movable between a closed position (visible in FIG. 1) in which it is biased upwards by a helical compression spring 11, and an open position in which it is moved downwards when the fuel pressure in the upstream chamber 5 is higher than a determined pressure. In this case, the pressure in the upstream chamber 5 exerts an axial force in the downward direction onto the metering valve 10 against the axial return force exerted by the spring 11.

The spring 11 has a first, lower, axial end 11a and a second, upper, axial end 11b. The first axial end 11a rests on a stationary element 12 mounted in the body 2 and forming the seat of the valve 10, in particular of the lower end 13 of the valve 10. The second axial end 11b of the spring 11 is supported by an annular collar 14 of the valve 10. The spring 11 consists of a single metal wire which is generally helical in shape and whose axial ends 11a, 11b generally extend in radial planes.

The lower part of the valve 10 has slots 15 whose geometries are such that the passage sections between the surfaces delimiting the slots 15 and the element 12 vary according to the axial position of the metering valve 10.

As mentioned above, the structure of such a helical compression spring 11 generates buckling stress and friction creating a hysteresis phenomenon that should be avoided.

For this purpose, the invention proposes to replace the spring 11 described with reference to FIG. 1 by a spring 11 whose structure is shown in FIG. 2. This spring has a first axial end 11a and a second axial end 11b which are annular and are connected to one another by at least two helical parts 11c, 11d which are elastically deformable in the axial direction. In the case of FIG. 2, the number of helical parts 11c, 11d is equal to two.

The helical parts 11c, 11d are evenly distributed around the circumference, i.e. diametrically opposed in pairs in the case of an even number of helical parts.

The number of turns of each helical part 11c, 11d is between 2 and 6, e.g. 3.5 turns in the case of FIG. 2, preferably between 2 and 3. The spring 11 is made in one piece from a metallic material, e.g. steel, titanium or a titanium alloy.

Each helical part 11c, 11d may have a round or polygonal, e.g. rectangular or square cross-section.

The different helical parts 11c, 11d have the same diameter.

The axial ends 11e of the helical parts 11c, 11d can be connected to the annular ends 11a, 11b of the spring 11 by areas with no break of slope, e.g. by inclined areas 16 or by curved areas 17, in order to locally limit the mechanical stresses.

Such a structure reduces buckling forces and friction so as to reduce hysteresis during operation and thus improve the operation and service life of the injector 1.

1. A fuel injector for a turbine engine, the injector comprising a body having a fuel inlet opening into an upstream chamber and a fuel outlet connected to a downstream chamber, a metering valve being mounted between the upstream chamber and the downstream chamber, said valve being subjected to the action of an elastic return spring tending to return the valve to a closed position, the spring and the valve being designed to allow the opening of the valve and to allow the passage of fuel from the upstream chamber to the downstream chamber above a given fuel pressure in the upstream chamber, the return spring extending along the axis of movement of the valve, characterized in that the spring has a first axial end and a second axial end which are annular and are connected to one another by at least two helical parts which are elastically deformable in the axial direction.

2. An injector according to claim 1, characterized in that the helical parts are evenly distributed over the circumference.

3. An injector according to claim 1, characterized in that the helical parts have the same diameter.

4. An injector according to claim 2, characterized in that the helical parts have the same diameter.

5. An injector according to claim 1, characterized in that the number of turns ranges from 2 to 3.

6. An injector according to claim 3, characterized in that the number of turns ranges from 2 to 3.

7. An injector according to claim 1, characterized in that the spring is made in one piece from a metallic material, for example steel, titanium or a titanium alloy.

8. An injector according to claim 2, characterized in that the spring is made in one piece from a metallic material, for example steel, titanium or a titanium alloy.

9. An injector according to claim 3, characterized in that the spring is made in one piece from a metallic material, for example steel, titanium or a titanium alloy.

10. An injector according to claim 4, characterized in that the spring is made in one piece from a metallic material, for example steel, titanium or a titanium alloy.

11. An injector according to claim 5, characterized in that the spring is made in one piece from a metallic material, for example steel, titanium or a titanium alloy.

12. An injector according to claim 6, characterized in that the spring is made in one piece from a metallic material, for example steel, titanium or a titanium alloy.
